(19) United States
(12) Patent Application Publication
(10) Pub. No.: US 2003/0069926 A1
(43) Pub. Date: Apr. 10, 2003

(54) System and method for managing an exchange between a gateway server and a client-side module

(76) Inventors: Jeffrey Charles Weaver, Englewood, CO (US); Andrew Wilson Sundelin, Denver, CO (US); Thomas Evans Moore, Englewood, CO (US)

Correspondence Address: COOLEY GODWARD LLP, ATTN: PATENT GROUP, 11951 FREEDOM DRIVE, SUITE 1700, ONE FREEDOM SQUARE- RESTON TOWN CENTER, RESTON, VA, 20190-5061, US

(21) Appl. No.: 09/974,665

(22) Filed: Oct. 9, 2001

(51) Int. Cl. G06F 15/16

(52) U.S. Cl. 709/203; 709/217

(57) ABSTRACT

A system and method for reducing the impact of high latency links for interactive applications is described. In one embodiment, a list identifying locally stored data, which correspond to a data page, is received. Additionally, an index page corresponding to the data page is received. This index page can include a list of data objects included in the web page. Next, a determination is made as to which data objects included in the index page are subject to a prefetch, and a corresponding prefetch request is generated.

### RELATED APPLICATIONS

The following commonly owned and assigned patent applications are hereby incorporated by reference in their entirety:

Amplitude Balanced Quadrature Amplitude Modulation, Ser. No. 09/713,125, filed Nov. 15, 2000;

Peak to Average Power Ration Minimizing Encoder, Ser. No. 09/713,127, filed Nov. 15, 2000; and

Performance Enhancing Proxyfor High Latency Data Links, Ser. No. (Attorney Docket No. WILD 001/00US), filed Oct. 9, 2001.

### FIELD OF THE INVENTION

The present invention relates to systems and methods for delivery of data. In particular, but not by way of limitation, the present invention relates to a system and method for reducing the impact of high latency links over satellite and wireless systems.

### BACKGROUND OF THE INVENTION

With the increasing demand for high-speed access to the Internet, Internet service providers and Internet users are increasingly turning to satellite networks. These satellite networks have the potential to offer significant coverage improvements over traditional, broadband terrestrial networks. Additionally, satellite networks allow for connections to the Internet to be established without the expense of laying an extensive network of terrestrial lines.

Even with all of the advantages offered by satellite networks, they suffer from significant drawbacks that limit their commercial appeal to Internet users. In particular, users accessing the Internet over a satellite network can experience lengthy delays. Although portions of this delay are inherent to satellite networks because of the large distances that signals must travel, much of the delay is caused by the use of inefficient protocols to transmit data over the satellite link.

Traditional data transmission protocols were designed for conventional terrestrial networks with relatively uniform low latencies between components. These traditional protocols, however, are extremely inefficient for satellite and wireless networks. For example, traditional protocols do not account for the fact that the latency between a gateway satellite dish 105 and a user satellite dish 110 is extremely high while the latency between the Internet 115 and, for example, a SMTS (Satellite Modem Termination System) 120 is relatively low. (See FIG. 1). Despite the drawbacks to using these traditional protocols over satellite systems, terrestrial Internet service providers and system designers continue to incorporate them into their technology. Moreover, because satellite Internet users want access to the same Internet content as terrestrial Internet users, satellite Internet users necessarily have to interface with standard Internet protocols designed for terrestrial use. The result of the continued use of these inefficient protocols has resulted in a commercial product that is often less than satisfactory and has slowed the adoption of an otherwise beneficial technology.

Some companies have recently undertaken an effort to maximize the efficiency of TCP/IP, one of the traditional data transmission protocols, with regard to satellite networks. For example, Flash Networks has developed a TCP/IP enhancement. This enhancement is described in PCT patent application WO9847166, entitled “Data Communication Protocol.” Although enhancements to TCP/IP somewhat improve the performance of satellite networks, TCP/IP enhancements alone are not sufficient to make Internet service via a satellite network a viable consumer product. Accordingly, further enhancements to transmission protocols are needed if Internet service provision through satellite networks is to become widespread.

Recent efforts to improve the performance of satellite networks have been directed toward enhancing HTTP, another of the traditional data transmission protocols. These efforts, however, have been generally unsatisfactory. Accordingly, a system and method are needed to meaningfully improve the performance of HTTP with regard to satellite networks. In particular, a system and method are needed to reduce the latency and thus increase the effective speed that a user experiences when accessing the Internet through a satellite network.

### SUMMARY OF THE INVENTION

In one innovative aspect of the present invention, a system and method for reducing the impact of high latency links, whether satellite links or wireless links, are disclosed. Briefly, this embodiment of the present invention reduces the impact of high latency satellite and wireless links by performing predictive prefetching and pushing of data objects needed by a user. Other embodiments are also described herein.

In one embodiment, for example, a user—through a web browser—initially requests a web page. This request is passed to a client PEP (performance enhancing proxy) that is often incorporated with the user's satellite modem. The client PEP then passes this request through the satellite network to the gateway PEP, which then passes the request to an origin server. Responsive to receiving the request, the origin server generates an index page (also called a container page) associated with the requested web page and passes that index page to the gateway PEP, which parses the index page to identify the objects listed therein. Next, the gateway PEP generates the requests to fetch, i.e., prefetch, those identified objects and passes those requests to the origin server. The origin PEP can also pass the index page and a list of those objects being prefetched to the client PEP. The client PEP can then pass at least the index page to the user.

As with the standard Internet, once the user receives the index page, it generates a fetch request for each—or at least some of—the objects identified therein. In a typical satellite-based system, these fetch requests would normally be passed through the satellite network to the origin server. However, in one embodiment of the present invention, the fetch requests, or at least some portion thereof, can be blocked, i.e., not passed to the origin server, by the client PEP because the client PEP knows that certain fetch requests are already being filled through the requests previously passed from the gateway PEP to the origin server.

In one embodiment, the gateway PEP assumes that all embedded objects are needed by the client PEP. In alternate embodiments, however, the gateway PEP can be made aware of the prior activities of the client PEP and prefetch or push only those objects not already cached by the client PEP. In either of these embodiments, however, when the origin server returns prefetched objects, these objects are passed through the satellite network to the client PEP and on to the user.

From the user's perspective, the objects were received as a result of the fetch requests that the user originated. In reality, however, the objects could have been requested long before the user's browser even generated those fetch requests. In some cases, the objects may be in the process of being transmitted to the client PEP even before the user receives the index page. Thus, the present invention can, among other things, minimize the impact of the high latency between the gateway satellite dish and the local satellite dish is minimized.

### BRIEF DESCRIPTION OF THE DRAWINGS

Various objects and advantages and a more complete understanding of the present invention are apparent and more readily appreciated by reference to the following Detailed Description and to the appended claims when taken in conjunction with the accompanying Drawings wherein:

FIG. 1 is a present satellite network system connecting a user with the Internet;

FIG. 2 is a satellite network system constructed in accordance with one embodiment of the present invention;

FIG. 3 is an alternate embodiment of a satellite network system constructed in accordance with one embodiment of the present invention;

FIG. 4 is an embodiment of a wireless network system constructed in accordance with the principles of the present invention;

FIG. 5 is a data flow diagram illustrating the data flow between the components of the system shown in FIG. 2;

FIG. 6 is a data flow diagram illustrating an alternate data flow between the components of the system shown in FIG. 2; and

FIG. 7 is a data flow diagram illustrating a bandwidth optimization technique in accordance with one embodiment of the present invention.

### DETAILED DESCRIPTION

Although the present invention is open to various modifications and alternative constructions, a preferred exemplary embodiment that is shown in the drawings is described herein in detail. It is to be understood, however, that there is no intention to limit the invention to the particular forms disclosed. One skilled in the art can recognize that there are numerous modifications, equivalents and alternative constructions that fall within the spirit and scope of the invention as expressed in the claims.

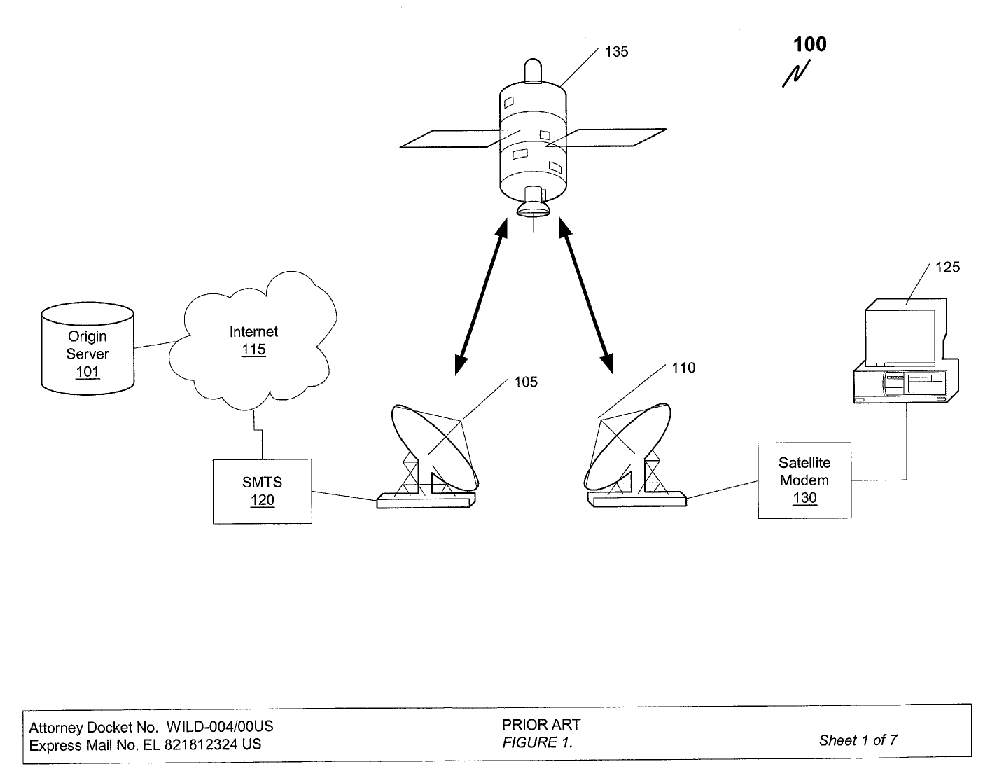

Referring now to FIG. 1, there is illustrated a present satellite network system 100 connecting a user 125 with the Internet 115. In this embodiment, the user 125 is connected to a satellite modem 130 and a local satellite dish 110. The user 125 receives data—in some cases both Internet and TV—from a gateway satellite dish 105 via a geostationary satellite 135. (Collectively the local satellite dish 110, the geostationary satellite 135 and the gateway satellite dish 105 are referred to as the “satellite system.”) The data that the gateway satellite dish 105 transmits to the user 125 can originate from the Internet 115 and origin server 101 or a broadcast system (not shown). The SMTS (Satellite Modem Termination System) 120 provides the necessary intelligence to bridge between the Internet 115 and the satellite system. This general configuration shown in FIG. 1 is similar to the system used for modern satellite TV systems. In fact, Hughes™ Network Systems offers a combination satellite TV system and Internet access (called “DirecDuo”™) using this general system.

Although the system described above has tremendous downloading capacity, this capacity is not readily accessible to a highly interactive activity such as web browsing. In fact, this downloading capacity presently is best used by non-interactive or low interactive activities such as streaming media or downloading large files. Those applications that require continued and frequent interaction between the user 125 and a device on the gateway side of the satellite system are often slow (1) because of the high latency between the gateway satellite dish 105 and the local satellite dish 110 and (2) because of the numerous roundtrip transmissions between the user 125 and the Internet 115 needed to successfully transfer data. Accordingly, the system shown in FIG. 1 is somewhat undesirable for many Internet applications and other highly interactive applications.

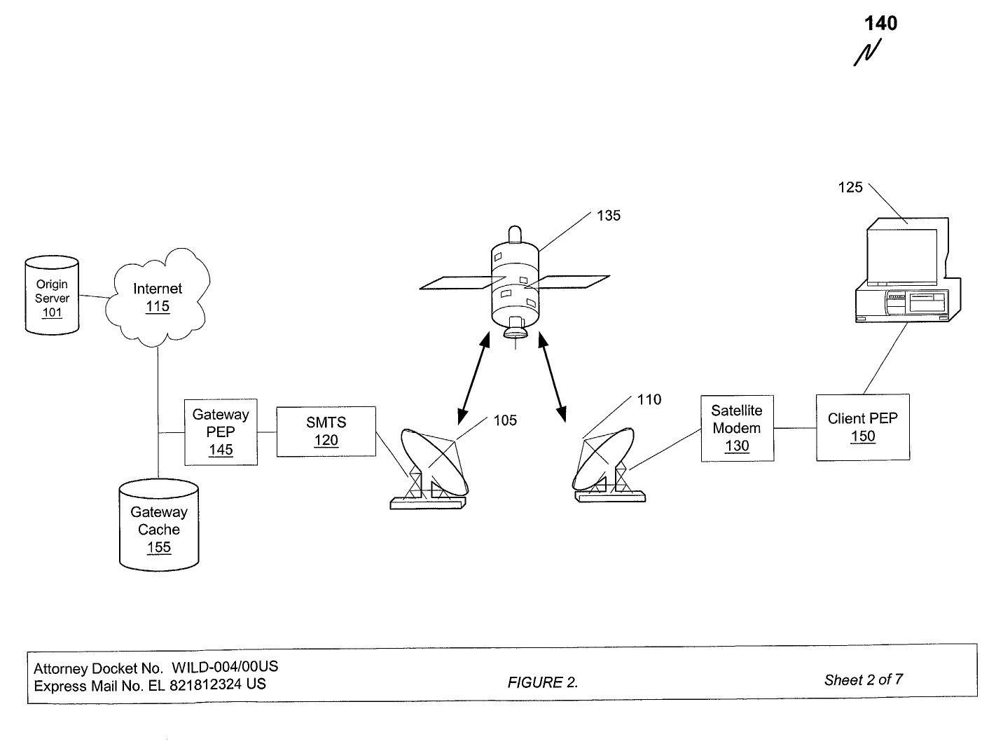

Referring now to FIG. 2, there is illustrated a satellite network system 140 constructed in accordance with the principles of the present invention. As with the system shown in FIG. 1, this system includes a gateway satellite dish 105, a local satellite dish 110, and a geostationary satellite 135. Unlike the system shown in FIG. 1, however, this embodiment of the present invention includes a gateway PEP (Performance Enhancing Proxy) 145, a client PEP 150 and a gateway cache 155. Although the client PEP 150 is shown separately from the satellite modem 130 and the user 125, in other embodiments, the client PEP 150 could be integrated into the satellite modem 130 and/or into the user's computer. For example, the client PEP 150 could be a browser plug-in or otherwise incorporated with the user's browser application.

The gateway PEP 145 and the client PEP 150 can replace or supplement traditional data transmission protocols, e.g., TCP/IP and HTTP, with a transport protocol that is optimized for a satellite network. For example, the protocol between the Internet 115 and the gateway PEP 145 could be TCP/IP and the protocol between the client PEP 150 and the user 125 could be TCP/IP. The protocol between the gateway satellite dish 105 and the local satellite dish 150, however, could be a satellite transport protocol instead of standard TCP/IP. In other words, the PEP can speak standard Internet protocols on one interface and satellite protocols on a different interface. Alternatively, the satellite transport protocol could replace traditional HTTP with an enhanced protocol. As those of skill in the art can understand, by replacing the traditional transmission protocols with a protocol optimized for a satellite network, interactive applications, e.g., web browsing, can better utilize the downloading capacity of a satellite network and thereby make interactive applications faster, more efficient and commercially viable.

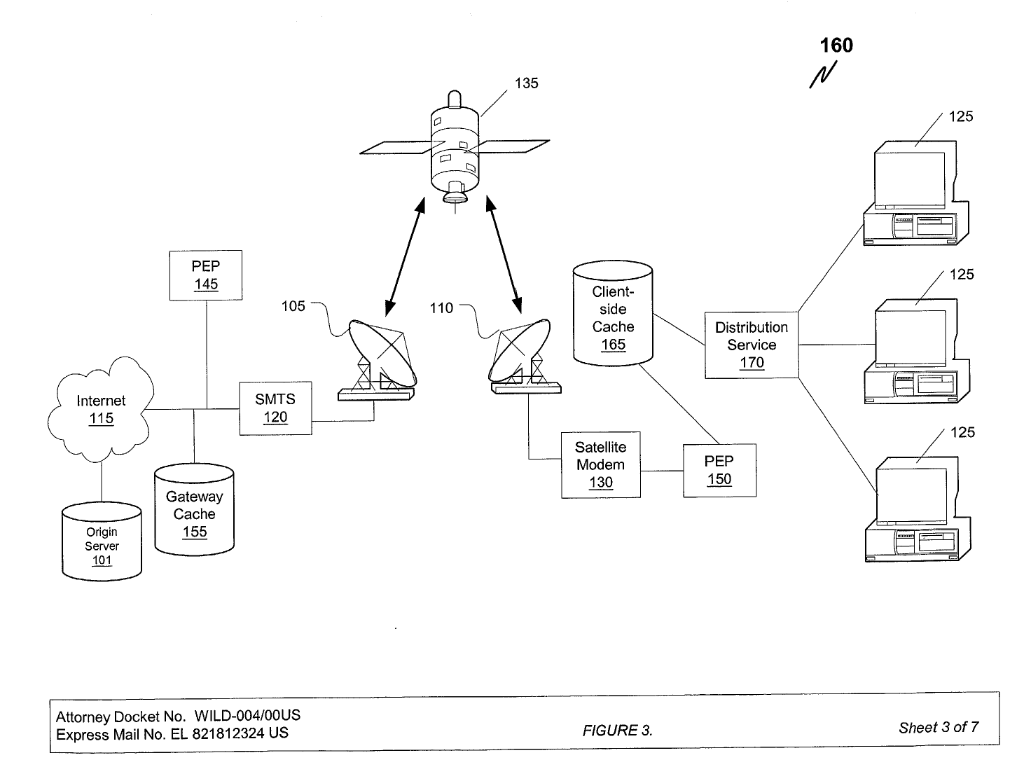

FIG. 3 illustrates an alternate embodiment of a satellite network system 160 constructed in accordance with the principles of the present invention. In this embodiment, a client-side cache 165 and distribution service 170 are disposed intermediate the local satellite dish 110 and the individual users 125. The distribution service 170 could be a MMDS (Multichannel Multipoint Distribution System), a LMDS (Local Multipoint Distribution System), or any other type of distribution service.

The operation of the system illustrated in FIG. 3 is similar to the operation of the system shown in FIG. 2. The client PEP 150, however, can be modified to interact with multiple users 125 rather than a single user. Additionally, the client PEP 150 could be modified to take advantage of a client-side cache 165, which could be resident in the same device as the PEP, thereby offering the PEP the advantages of local storage.

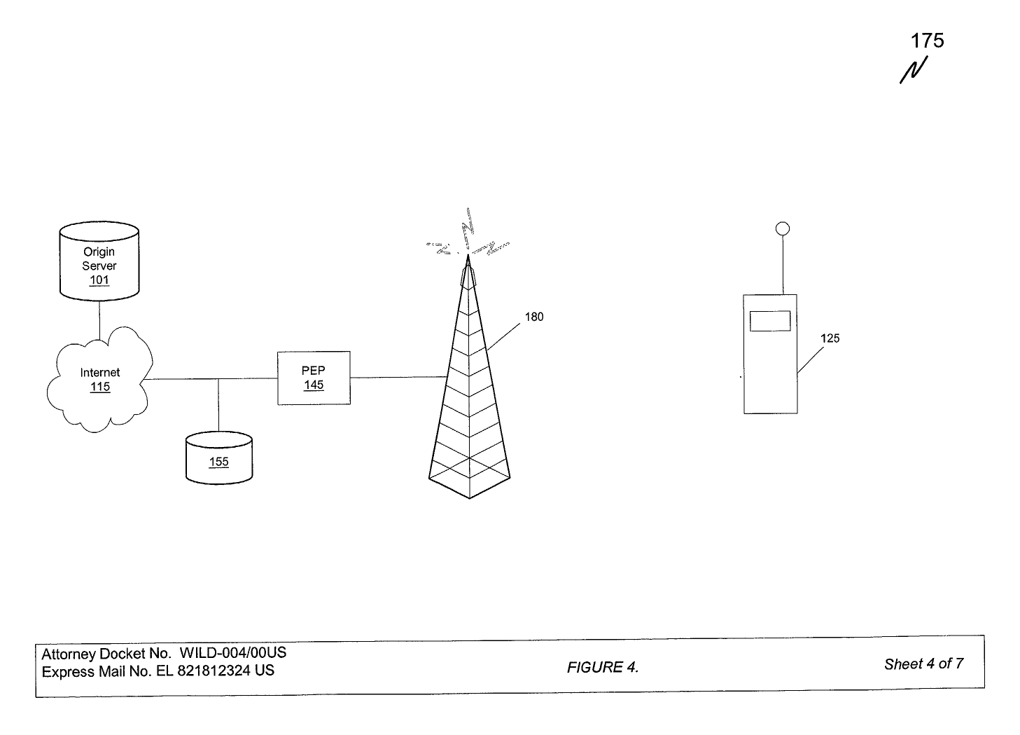

Referring now to FIG. 4, there is illustrated an embodiment of a wireless network system 175 constructed in accordance with the principles of the present invention. In this embodiment, the gateway PEP 145 is disposed between the Internet 115 and a wireless broadcast device 180. The gateway PEP 145 could enhance or modify the transmission protocols used by the wireless broadcast device 180 and thereby provide optimizations similar to those achieved in the previously-described satellite network systems.

Notably, the user 125 could be any type of wireless-adapted device ranging from a PDA to a cell phone to a wireless-connected mobile computer. In the preferred embodiment, the user 125 would incorporate a client PEP or at least portions of a PEP. Moreover, the user could include storage for storing data used by the client PEP.

The operation of the present invention is best illustrated by example. Although the following examples involve an Internet application, one skilled in the art can recognize that the present invention can be applied to other types of interactive applications. Moreover, the following examples recite the execution of events in a particular order. The order of these events is exemplary only, and the present invention is not necessarily limited to the recited order.

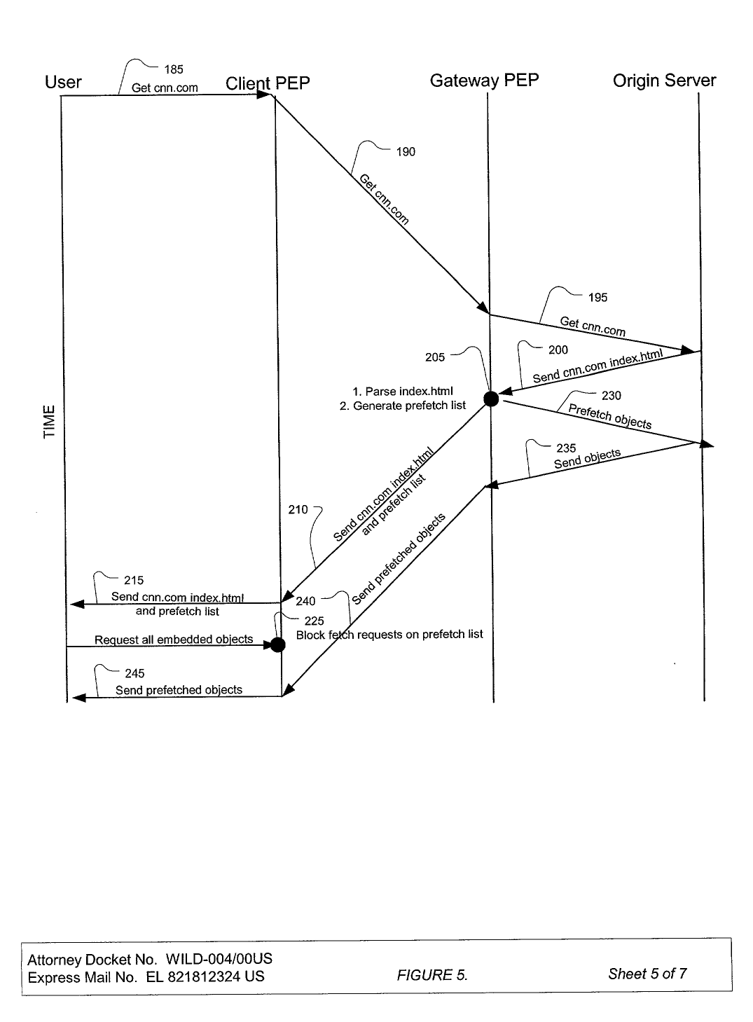

FIG. 5 illustrates the data flow between the components of the system shown in FIG. 2. In this embodiment, the user, through a browser, sends a request to the client PEP (step 185). For example, the user could issue a “get cnn.com” request. The client PEP would then pass this request—through the satellite system—to the gateway PEP (step 190), which would then pass the request to an Internet-connected (or other network) origin server (step 195). Next, the origin server would return an index page to the gateway PEP (step 200). The gateway PEP would then parse the index page (step 205) to identify the objects within the page, generate a prefetch list (step 205), and attempt to prefetch the objects included in the prefetch list (step 230). Although the exact timing is not necessarily relevant, the gateway PEP next sends the index page and a list of the objects being prefetched to the client PEP (step 210). The client PEP passes the index page to the user (step 215) and in certain embodiments, the client PEP also passes the list of objects being prefetched to the user (step 215).

Assuming that the user includes a standard commercial browser, upon receiving the index page, the user generates GET requests for the objects identified in the index page and passes those requests to the client PEP (step 220). Because the client PEP has been told by the gateway PEP which objects that the gateway PEP is prefetching on its behalf (via the object list), the client PEP knows what objects may already be in transit from the gateway PEP. If the client PEP receives GET requests from the user's browser for objects on the object list, the client PEP blocks the requests (step 225), i.e., does not forward the requests, because it is already anticipating delivery of these objects. The user, however, does not necessarily know that the fetch requests have been blocked.

Concurrently, or generally concurrently, with certain ones of the previously described steps, the gateway PEP requests the index page objects from the origin server (step 230). The origin server sends the requested objects to the gateway PEP (step 235), and the gateway PEP passes those objects to the client PEP (step 240). Finally, the retrieved objects can be passed to the user (step 245) so that the user can assemble the objects and display the requested web page.

As can be appreciated by those of skill in the art, the above-described method presents a significant improvement over existing technology. In particular, the above-described method minimizes the impact of high latency links in satellite and wireless networks by, for example, minimizing the number of round trip interacts necessary to retrieve data. Instead of requiring the user to actually wait for an index page and then request the objects identified therein, this implementation may anticipate the needs of the user, fetch those objects before the user actually requests them and push them to the user/client PEP. Because the high latency link is generally higher latency than typical Internet latency to the origin server, these objects can often be pushed before the index page has even arrived at the end user. Thus, objects needed by a user may be in transit to the user before the user even requests them. If the objects are not needed, the client PEP can merely discard them or store them locally for future use.

Another distinct advantage of this embodiment of the present invention involves its use of existing technology. For example, one embodiment of the present invention incorporates existing browser technology. In other words, the user's browser does not necessarily need to be modified to benefit from the present invention. The browser generates the same requests that it would in a normal system. However, the client PEP intercepts these requests and blocks them if appropriate. By allowing the user to use a standard browser, systems in accordance with various aspects of the present invention can increase commercial appeal because, in essence, the user need only replace his standard modem with a satellite modem and a client PEP, which as previously described, can be a single, integrated product.

The advantage of this embodiment of the invention's use of existing technology at the end points (i.e., the browser and the origin server do not have to change) can be enhanced when the addition of advance technologies such as multicast are added into the system. The gateway PEP and client PEP can utilize mulitcast between them generally without any changes to the origin server or browser. This means that a variety of business rules can be applied by the gateway PEP to determine whether to mulitcast or unicast responses to client PEPs. For example, the gateway PEP could track popular content and mulitcast content responses for these URLS. Alternatively, subscribers could indicate interest groups and when requests are made for content in those interest groups, the responses are mulitcast to the group, not just unicast to the requester. The advantage of this approach is that the same amount of bandwidth can be consumed by unicast traffic as by multicast traffic and, by doing this with the PEPs, the activity is transparent to the end points.

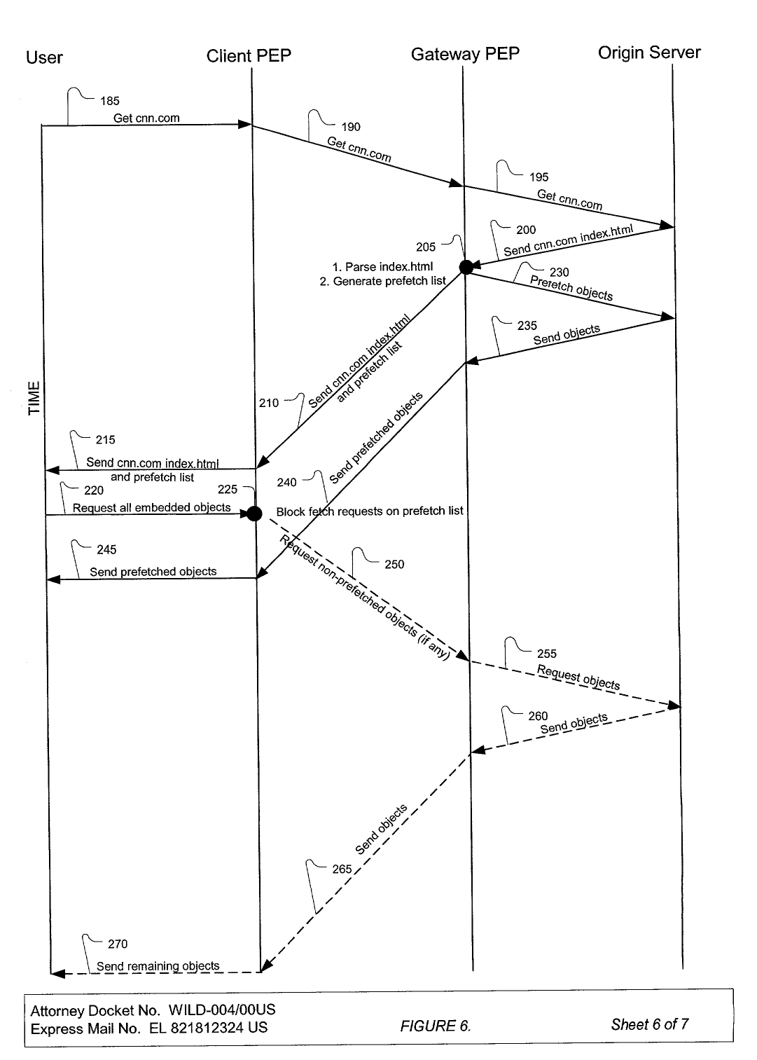

FIG. 6 is a data flow diagram illustrating an alternate data flow between the components of FIG. 2. Generally, steps 185-245 of FIG. 6 are similar to the correspondingly numbered steps in FIG. 5. In the data flow of FIG. 6, however, certain objects were not subjected to a prefetch in step 230 and not provided to the user in step 245. Thus, in this embodiment, the client PEP passes requests for these non-prefetched objects to the gateway PEP (step 250). The gateway PEP then passes the requests to the origin server (step 255). The origin server can then retrieve the objects corresponding to the request and transmit those objects to the gateway PEP (step 260). The gateway PEP can then pass the objects to the client PEP (265), and finally, the client PEP can pass the objects to the user (step 270) for combination with the objects received in step 245.

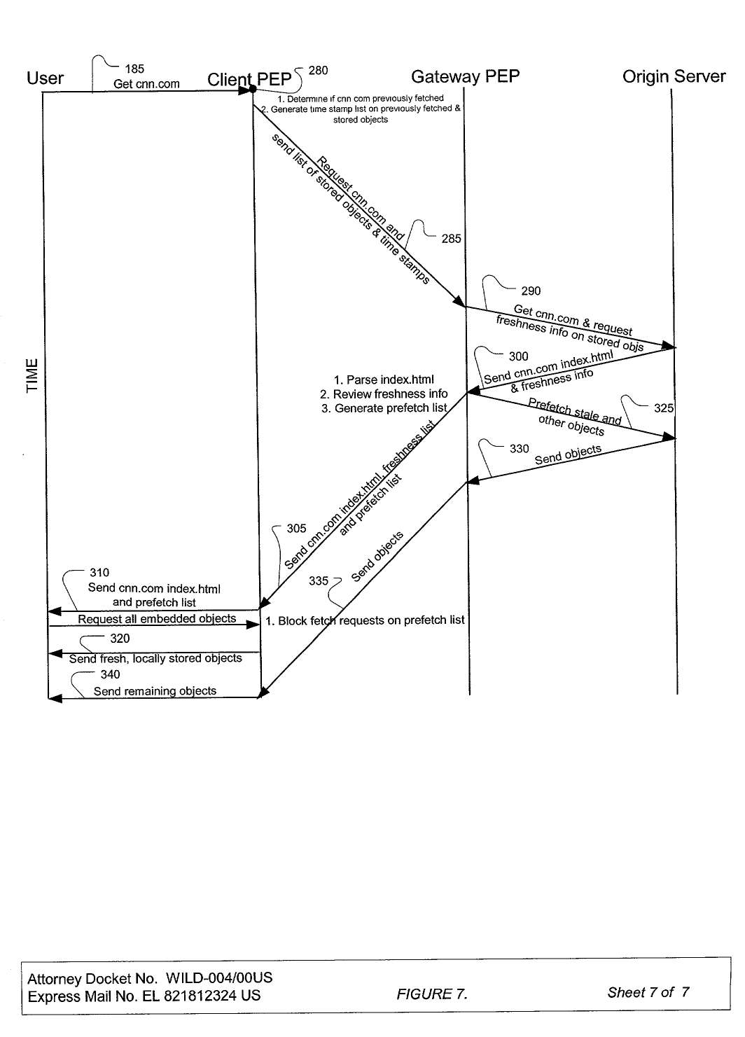

Referring now to FIG. 7, it is a data flow diagram illustrating a method of optimizing bandwidth in accordance with one embodiment of the present invention. As with the embodiment shown in FIG. 5, the user initially passes a request, e.g., get cnn.com, to the client PEP (step 185). The client PEP intercepts this request and determines if the request—or a portion of the request—has been previously filled (step 280). Furthermore, the client PEP can generate a time stamp list corresponding to previously fetched and stored objects (step 280). The client PEP can pass both the request and the list of stored objects and time stamps to the gateway PEP (step 285), and the gateway PEP can pass the request and list on to the origin server (step 290).

After receiving a request and a list of previously fetched objects, the origin server can return an index page and object freshness information to the gateway PEP (step 295). The gateway PEP can then parse the index page, review the freshness information, and generate a prefetch list based on the index page and freshness information (step 300). The gateway PEP can then pass the index page, the prefetch list, and/or the freshness information to the client PEP (step 305). Next, the client PEP can pass the index page and the prefetch list on to the user (step 310). Responsive to receiving the index page and the prefetch list, the user requests the embedded objects identified in the index page (step 315). The client PEP responds to this request by returning any fresh, locally stored data objects that correspond to the user's requests (step 315).

In parallel with certain previously described steps, the gateway PEP prefetches stale and other objects needed to fill the user's requests (step 325). These objects are returned by the origin server and passed through to the client PEP to the user (steps 330, 335, and 340). The user can then combine the objects received in step 320 with the objects received in step 340, thereby filling the request made in step 315.

In another embodiment of the present invention (not illustrated), the gateway PEP rather than the client PEP can determine whether an initial request has been previously filled. In other words, the gateway PEP can keep track of what objects have been provided to the client PEP and whether or not those objects are still valid. Otherwise, the operation of this embodiment is similar to the operation described with relation to FIG. 7. As those of skill in the art can understand, one advantage of this embodiment is that the amount of data that needs to be transferred can be reduced.

In conclusion, the present system provides, among other things, a system and method for reducing the impact of high latency links on interactive applications. Those skilled in the art, however, can readily recognize that numerous variations and substitutions may be made in the invention, its use and its configuration to achieve substantially the same results as achieved by the embodiments described herein. Accordingly, there is no intention to limit the invention to the disclosed exemplary forms. Many variations, modifications and alternative constructions fall within the scope and spirit of the disclosed invention as expressed in the claims.

What is claimed is:

1. A method for managing a data transmission, the method comprising:
receiving, at a gateway PEP, a fetch request for a web page;
receiving, at the gateway PEP, a list of locally available data objects, wherein the list of locally available data objects corresponds to the web page;
passing the fetch request to a gateway server;
receiving, at the gateway PEP, an index page corresponding to the web page, wherein the index page comprises a list of data objects included in the web page;
comparing the list of locally available data objects with the list of data objects identified in the index page to determine which data objects included in the index page are subject to prefetch; and
generating, at the gateway PEP, a prefetch request corresponding to the data objects determined to be subject to prefetch.

2. The method of claim 1, further comprising:
receiving a timestamp associated with a first of the identified locally available data objects.

3. The method of claim 2, further comprising:
comparing the timestamp to a threshold time limit to determine whether the first of the locally available data objects is valid;
wherein the first of the identified locally available data objects is subject to prefetch if the timestamp indicates that the first of the identified locally stored data objects is older than the threshold time limit.

4. The method of claim 1, wherein receiving the list of locally available data objects comprises:
receiving the list of locally available data objects from a gateway-side storage device.

5. The method of claim 1, wherein receiving the list of locally available data objects comprises:
receiving the list from a client-side storage device.

6. The method of claim 1, wherein the locally available data objects are stored locally relative to the gateway PEP.

7. The method of claim 1, wherein the locally available data objects are stored locally relative to a browser.

8. The method of claim 1, further comprising:
receiving data objects corresponding to the prefetch request; and
passing the received data objects to a client.

9. The method of claim 1, further comprising:
passing the generated prefetch requests to the gateway PEP.

10. A method for managing a data transmission, the method comprising:
receiving a list identifying locally stored data objects, wherein the identified locally stored data objects correspond to a data page;
receiving an index page corresponding to the data page, wherein the index page comprises a list of data objects included in the web page;
determining which data objects included in the index page are subject to a prefetch, wherein the determination is based upon the received list and the received index page; and
generating a prefetch request corresponding to the data objects determined to be subject to the prefetch.

11. The method of claim 10, further comprising:
receiving a timestamp associated with a first of the identified locally stored data objects.

12. The method of claim 11, further comprising:
comparing the timestamp to a threshold time limit to determine whether the first of the identified locally stored data objects is valid.

13. The method of claim 10, further comprising:
receiving data objects corresponding to the prefetch request; and
passing the received data objects to a client-side device.

14. A system for managing a data transmission, the system comprising:
at least a first processor device;
at least a first memory device coupled to the at least a first processor device;
a plurality of instructions stored on the at least a first memory device, the plurality of instructions configured to cause the at least a first processor to:
process a list identifying locally stored data objects, wherein the identified locally stored data objects correspond to a data page;
process an index page corresponding to the data page, wherein the index page comprises a list of data objects included in the web page;
determine which data objects included in the index page are subject to prefetch, wherein the determination is based upon the received list and the received index page; and
generate a prefetch request corresponding to the data objects determined to be subject to prefetch.

15. The system of claim 14, wherein the plurality of instructions are further configured to cause the at least a first processor to:
process a timestamp associated with at least a first of the identified locally stored data objects.

16. The system of claim 14, wherein the plurality of instructions are further configured to cause the at least a first processor to:
compare the timestamp to a threshold time limit to determine whether the at least a first of the identified locally stored data objects is valid.

17. The system of claim 16, wherein the plurality of instructions are further configured to cause the at least a first processor to:
receive data objects corresponding to the prefetch request; and
pass the received data objects to a client-side device.

18. A method for providing data from a gateway server to a client-side module, the method comprising:
receiving, at a gateway performance enhancing proxy (PEP), a request for a data page;
providing the received request to a gateway server;
receiving, at the gateway PEP, an index page identifying at least a first data object included in the data page;
providing the index page to the client-side module;
generating a list of data objects subject to a prefetch, wherein the list of data objects includes an indication of the at least a first data object;
providing the list of data objects to the client-side module;
providing a fetch request to the gateway server, the fetch request corresponding to the at least a first data object;
responsive to providing the fetch request to the gateway server, receiving the first data object from the gateway server; and
providing the first data object to the client-side module.

19. The method of claim 18, wherein receiving a request for a data page comprises:
receiving a request for a web page.

20. The method of claim 18, wherein providing the list of data object comprises:
multicasting the list of data objects to at least the client-side module.

21. The method of claim 18, further comprising:
generating the fetch request at the gateway PEP.

22. The method of claim 18, wherein providing the first data object to the browser comprises:
providing the first data object to the browser via a satellite network.

23. A method for providing data from a gateway server to a client-side module, the method comprising:
receiving an index page indicating at least a first data object included in a data page;
providing the index page to the client-side module;
generating a list of data objects subject to a prefetch, wherein the list of data objects includes the at least a first data object;
providing a fetch request to the gateway server, the fetch request corresponding to the list of data objects subject to prefetch;
responsive to providing the fetch request to the gateway server, receiving the first data object from the gateway server; and
providing the first data object to the client-side module.

24. The method of claim 23, wherein generating the list of data objects subject to the prefetch comprises:
parsing the index page.

25. The method of claim 23, further comprising:
generating the fetch request at a gateway PEP.

26. The method of claim 23, wherein providing the first data object to the client-side module comprises:
providing the first data object to the client-side module via a satellite network.

27. A system for managing a data transmission, the system comprising:
a child PEP;
a satellite modem coupled to the child PEP;
a satellite modem termination system;
a satellite system coupled to the satellite modem and the satellite modem termination system; and
a parent PEP coupled to the satellite system.

28. The system of claim 27, wherein the child PEP is configured to intercept a data page fetch request generated by a browser and wherein the child PEP is configured to block the data page fetch request, thereby preventing the data page fetch request from being sent over the satellite system from the browser to a gateway server.

29. The system of claim 27, wherein the satellite modem and the child PEP are integrated.

30. The system of claim 27, wherein the parent PEP is configured to generate a list of data objects subject to a prefetch, wherein the list of data objects includes the at least a first data object.

31. The system of claim 30, wherein the parent PEP is configured to provide a fetch request to the gateway server, the fetch request corresponding to the indication the first data object.

32. The system of claim 27, further comprising:
a multipoint distribution system coupled to the child PEP;
wherein a plurality of users are connectable to the mulitpoint distribution system.

33. A system for managing a data transmission between a gateway server and a client-side module, the system comprising:
at least a first processor device;
at least a first memory device coupled to the at least a first processor device; and
a plurality of instructions stored on the at least a first memory device, the plurality of instructions configured to cause the at least a first processor to:
process a request for a data page;
provide the received request to the gateway server;
receive an index page identifying at least a first data object included in the data page;
provide the index page to the client-side module;
generate a list of data objects subject to a prefetch, wherein the list of data objects includes an indication the at least a first data object; and
provide the list of data objects to the client-side module;
provide a prefetch request to the gateway server, the prefetch request corresponding to the at least a first data object;
responsive to providing the prefetch request to the gateway server, process the first data object, wherein the first data object is received from the gateway server; and
provide the first data object to the client-side module.

34. The system of claim 33, wherein the plurality of instructions are configured to cause the at least a first processor to generate the list of data objects subject to the prefetch by:
parsing the index page.

35. The system of claim 33, further comprising:
a multipoint distribution system;
wherein a plurality of users are connectable to the mulitpoint distribution system.

36. A system for providing data from a gateway server to a client-side module, the system comprising:
means for receiving a request for a data page;
means for providing the received request to a gateway server;
means for receiving an index page identifying at least a first data object included in the data page;
means for providing the index page to the client-side module;
means for generating a list of data objects subject to a prefetch, wherein the list of data objects includes an indication of the at least a first data object;
means for providing the list of data objects to the client-side module;
means for providing a fetch request to the gateway server, the fetch request corresponding to the at least a first data object;
means for receiving the first data object from the gateway server; and
means for providing the first data object to the client-side module.
